(19) United States
(12) Patent Application Publication
(10) Pub. No.: US 2023/0243077 A1
(43) Pub. Date: Aug. 3, 2023

(54) METHOD AND DEVICE FOR PRODUCING AN ANNULAR MULTIAXIAL LAID FABRIC AND AN ANNULAR OBJECT PRODUCED THEREWITH

(71) Applicants: KARL MAYER technische Textilien GmbH, Chemnitz (DE); The Goodyear Tire & Rubber Company, Akron, OH (US)

(72) Inventors: Peter Rotter, Helmbrechts (DE); René Glöckner, Freiberg (DE); Mike Rickmann, Plauen (DE); Jürgen Tröltzsch, Chemnitz (DE); Francesco Sportelli, Bettembourg (LU); Claude Boes, Erpeldanger-sur-Sure (LU); Stefan Wilms, Helmdange (LU); Romain Jack Rodolphe Mersch, Boust (FR); Joseph Carmine Lettieri, Hudson, OH (US); Robert Allen Losey, Kent, OH (US); Daniel Ray Downing, Uniontown, OH (US)

(21) Appl. No.: 17/649,231

(22) Filed: Jan. 28, 2022

(51) Int. Cl. D04H 3/073; D04H 3/009; D04H 3/12; D04H 3/10

(52) U.S. Cl. CPC D04H 3/073; D04H 3/009; D04H 3/10; D04H 3/12; D10B 2505/12

(57) ABSTRACT

The invention relates to a method and a device for producing an annular multiaxial laid fabric and to an annular object produced therewith. The object of the invention is therefore to create a method and a device for forming a multiaxial laid fabric for annular structures which has no twisting or displacement of the thread layers. Furthermore, it should no longer be necessary to close a butt join or overlap separately to form a closed ring of the multiaxial laid fabric. This object is achieved in that at least a lower thread layer (2a) and an upper thread layer in the form of an endless thread array or an endless single thread, or in the form of thread-array sections or single-thread sections, are laid around the entire circumference of two mutually spaced ring elements (3) with differing thread orientations, and the first and upper thread layers (2a, 2b) are then fixed to each other at points.

### FIELD OF THE INVENTION

The invention relates to a method and a device for producing an annular multiaxial laid fabric and to an annular object produced therewith.

### BACKGROUND OF THE DISCLOSURE

Multiaxial laid fabrics are used in particular in the production of composite fibre materials. In this case, these multiaxial laid fabrics are incorporated as reinforcement in a polymer matrix, where the polymer matrix can consist of polyester resin or epoxy resin, for example. To form a multiaxial laid fabric, parallel threads are laid one on top of the other in at least a lower thread layer and an upper thread layer, where the orientation of the threads in the lower thread layer differs from the orientation of the threads in the upper thread layer. After the two thread layers have been laid one on top of the other, the threads of the lower thread layer and the threads of the upper thread layer are joined to each other at points. For example, the threads can be stitch bonded, stapled or else thermally bonded to each other. In the following, “thread” is understood to mean a linear product of textile character, such as a yarn, filament or ribbon. The threads of the laid fabric can consist, for example, of carbon, glass or ceramic. Synthetic fibres, such as aramid or polyamide fibres, are also used.

DE 197 26 831 C5 discloses a multiaxial machine for forming a multiaxial laid fabric. This multiaxial machine has two mutually spaced, elongated transport elements, which are formed with fixing elements, the transport direction of which runs in the longitudinal direction of the multiaxial laid fabric produced. The transport elements in this case are in the form of driven transport chains. First, a lower thread layer in the form of an endless thread array is laid on the transport chains using a first thread-laying unit, which is guided on a feed gantry transverse to the transport direction of the transport chains, the laid thread array being laid around rows of needles, pins or hooks (fixing elements) attached to the transport chains. The feed gantry is movable at an adjustable speed along the movement direction of the transport chains. The speed of the thread-laying unit guided on the feed gantry is also adjustable. The orientation of the threads of the laid thread array relative to the transport direction of the transport chains can be defined via the interplay between the transport speed of the transport chains, the speed of movement of the feed gantry, and the speed of movement of the thread-laying unit. The threads can be oriented such that, between the threads and the transport direction of the multiaxial laid fabric produced, there is an angle of 0 degrees (threads are parallel to the transport direction), an angle of 90 degrees (threads are at a right angle to the transport direction) or an angle between 0 degrees and 90 degrees. An upper thread layer is then laid in an analogous manner on the lower thread layer, the orientation of the threads of the upper thread layer differing from the orientation of the threads of the lower thread layer. Further thread layers can be laid on the upper thread layer, depending on the application. Furthermore, inlays, such as films, foams or textiles, can be laid between thread layers lying one on top of the other. Once the desired number of thread layers has been laid, the threads of the thread layers are joined at least locally to one another using a fixing unit and then wound up into rolls.

A similar multiaxial machine is known from DE 10 2007 024 124 B3, in which the fixing unit is a stitching machine that stitches the threads of the thread layers with a stitch-bonding thread.

With the multiaxial machines known from the prior art, multiaxial laid fabrics have been produced continuously in rolls until now. If the multiaxial laid fabrics are to be used a fibre reinforcement in curved or annular structures, they must be curved accordingly. This requires a tight curve, in particular for completely closed annular structures. However, this results in twisting and displacement of the thread layers relative to one another. Furthermore, a butt joint or overlap is formed, which must be separately closed. It is disadvantageous that inhomogeneities are produced in the multiaxial laid fabric owing to the twisting and displacement of the thread layers and the subsequently closed butt joint or overlap, which can ultimately have a negative influence on the load-bearing capacity of the annular structures.

### BRIEF SUMMARY OF THE INVENTION

A first embodiment of the invention is a method for producing an annular multiaxial laid fabric (2), which is constructed from at least two thread layers (2a, 2b) laid one on top of the other, the method comprising the following steps: laying of a lower thread layer (2a) in the form of an endless thread array or an endless single thread, or in the form of thread-array sections or single-thread sections, around the entire circumference of two mutually spaced ring elements (3), the thread array or the single thread, or the thread-array sections or the single-thread sections, of the lower thread layer being held temporarily, after laying, by thread-holding elements (4) arranged around the ring circumference, and the threads of the thread array or the thread-array sections or the single thread or the single-thread sections of the lower thread layer (2a) forming an angle (α) within the range greater than 0 degrees up to 90 degrees to the circumferential direction (8) of the ring elements (3); laying of a upper thread layer (2b) in the form of an endless thread array or an endless single thread, or in the form of thread-array sections or single-thread sections, around the entire circumference of the two mutually spaced ring elements (3), the thread array or the single thread, or the thread-array sections or the single-thread sections, of the upper thread layer (2b) being held temporarily, after laying, by the thread-holding elements (4) arranged around the ring circumference, and the threads of the thread array or the single thread, or the thread-array sections or the single-thread sections, of the upper thread layer (2b) forming an angle (β) greater than 0 degrees to the threads of the thread array or the single thread, or the thread-array sections or the single-thread sections, of the lower thread layer (2a); fixing the threads of the thread array or the single thread, or the thread-array sections or the single-thread sections, of the lower thread layer (2a) at points to the threads of the thread array or the single thread, or the thread-array sections or the single-thread sections, of the upper thread layer (2b) by means of a fixing unit (10) around the circumference of the first and upper thread layers (2a, 2b) laid in a ring; detaching the first and upper thread layers (2a, 2b) from the thread-holding elements (4); and removing the annular multiaxial laid fabric (2) from the mutually spaced ring elements (3).

A second embodiment of the invention is a method according to the first embodiment, characterised in that at least one further thread layer (2c, 2b) in the form of an endless thread array or an endless single thread, or in the form of thread-array sections or single-thread sections, is laid around the entire circumference of the two mutually spaced ring elements (3) between the first and upper thread layers (2a, 2b), the thread array or the single thread, or the thread-array sections or the single-thread sections, of the further thread layer (2c, 2b) being held temporarily, after laying, by the thread-holding elements (4) arranged around the ring circumference (3), and the threads of the thread array or the single thread, or the thread-array sections or the single-thread sections, of the further thread layer (2c, 2b) forming an angle greater than 0 degrees to the threads of the thread array or the single thread, or the thread-array sections or the single-thread sections, of the first and upper thread layers (2a, 2b).

A third embodiment of the invention is a method according to the second embodiment, characterised in that two or more further thread layers (2c, 2d) are laid between the first and upper thread layers (2a, 2b), the threads of the thread array or the single thread, or the thread-array sections or the single-thread sections, of the further thread layer (2c, 2d) forming an angle greater than 0 degrees to the threads of the thread array or the single thread, or the thread-array sections or the single-thread sections, of the respectively adjacent thread layers (2a, 2b, 2c, 2d).

A fourth embodiment of the invention is a method according to any one of the first through third embodiments, characterised in that the threads of the thread array or the single thread, or the thread-array sections or the single-thread sections, of the lower thread layer (2a) and/or the upper thread layer (2b) and/or the further thread layer (2c, 2d) and/or the further thread layers (2c, 2d) are formed from identical or differing materials.

A fifth embodiment of the invention is a method according to any one of the first through fourth embodiments, characterised in that the threads within one of the thread arrays or thread array sections are formed from identical or differing materials.

A six embodiment of the invention is a method according to any one of the first through fifth embodiments, characterised in that, for the fixing of the thread layers (2a, 2b, 2c, 2d) at points, the threads are stitch-bonded with a stitch-bonding thread or stapled with staple elements or thermally fixed.

A seventh embodiment of the invention is a method according to any one of the first through sixth embodiments, characterised in that, after the lower thread layer (2a) has been laid, or after the further thread layer (2c, 2d) has been laid, or after the upper thread layer (2b) has been laid, a flat layer material (13) or a filler-thread layer is laid around the entire circumference.

An eighth embodiment of the invention is a method according to the seventh embodiment, characterised in that the flat layer material (13) is a separating film and/or a nonwoven fabric and/or a spacer fabric.

A ninth embodiment of the invention is a method according to any one of the first through eighth embodiments, characterised in that, after the threads of the thread layers (2a, 2b, 2c, 2d) have been fixed at points, a polymeric matrix material is applied to an inner side of the annular multiaxial laid fabric (2) and/or an outer side of the annular multiaxial laid fabric (2).

A tenth embodiment of the invention is a multiaxial machine (1) for producing an annular multiaxial laid fabric (2), characterised in that the multiaxial machine (1) has two mutually spaced ring elements (3), which are fixed in position relative to each other and have thread-holding elements (4), arranged around the ring circumference; at least one first thread-laying unit (6), which is guided on a first feed gantry (5) and is supplied by a first thread feed, for laying at least a lower thread layer (2a) and a upper thread layer (2b) in the form of an endless thread array or an endless single thread, or in the form of thread-array sections or single-thread sections, on the two mutually spaced ring elements (3); and a fixing unit (10) for locally fixing the threads of the first and upper thread layers (2a, 2b) laid on the ring elements; and that the first thread-laying unit (6) is movable on the first feed gantry (5) to and fro between the ring elements (3) transverse to the circumferential direction (8) of the ring elements (3); and that the first feed gantry (5) and the ring elements (3) which are fixed in position relative to each other can be rotated relative to each other in the circumferential direction (8).

An eleventh of the invention is a multiaxial machine (1) according to the tenth embodiment, characterised in that it has at least one second thread-laying unit, which is guided on a second feed gantry and is supplied by a second thread feed, for laying a further thread layer (2c, 2d) in the form of an endless thread array or an endless single thread, or in the form of thread-array sections or single-thread sections, on the two mutually spaced ring elements, and that the second thread-laying unit is movable on the second feed gantry to and fro between the ring elements (3) transverse to the circumferential direction (8) of the ring elements (3), and that the second feed gantry and the ring elements (3) which are fixed in position relative to each other can be rotated relative to each other in the circumferential direction (8).

A twelfth embodiment of the invention is a multiaxial machine (1) according to the tenth or eleventh embodiment, characterised in that an outer contour of the two ring elements (3) is congruent or that an outer contour of one ring element (3) is larger than an outer contour of the other ring element (3).

A thirteenth embodiment of the invention is a multiaxial machine (1) according to any one of tenth through twelfth embodiments, characterised in that it has a feed device (12) for feeding and laying a flat layer material (13) on the thread layer (2a, 2b) and/or the further thread layer (2c, 2d).

A fourteenth embodiment of the invention is a multiaxial machine (1) according to any one of tenth through thirteenth embodiments, characterised in that the fixing unit (19) is a stapling unit, a stitch-bonding unit or a heating unit.

A fifteenth embodiment of the invention is a multiaxial machine (1) according to any one of the tenth through fourteenth embodiments, characterised in that a supporting element (14) for supporting the lower thread layer (2a) laid on the ring elements (3) is provided between the two mutually spaced ring elements (3) at least in some sections around the ring circumference.

A sixteenth embodiment of the invention is a multiaxial machine (1) according to the fifteenth embodiment, characterised in that the supporting element (14) is a strip element which runs in at least some sections around the ring circumference.

A seventeenth embodiment of the invention is a multiaxial machine (1) according to any one of tenth through sixteenth embodiments, characterised in that the ring elements (3) have a circular or oval or elliptical outer contour.

An eighteenth embodiment of the invention is a multiaxial machine (1) according to any one of tenth through sixteenth embodiments, characterised in that the ring elements (3) have an outer contour in the shape of a regular polygon.

A nineteenth embodiment of the invention is a multiaxial machine (1) according to any one of the tenth through eighteenth embodiments, characterised in that the thread-holding elements (4) are needles which in each case of each of the ring elements (3) form a crown of needles along the ring elements (3), or that the thread-holding elements (4) are clamping elements arranged along the ring elements (3).

A twentieth embodiment of the invention is an annular object, characterised in that it contains an annular multiaxial laid fabric (2) produced by a method according to any one of the first through ninth embodiments.

A twenty-first embodiment of the invention is an annular object according to the twentieth embodiment, characterised in that the threads of the lower thread layer (2a) and/or of the upper thread layer (2b) and/or of the further thread layer (2c, 2d) and/or of the further thread layers (2c, 2d) and/or the flat layer material (13) are formed from polyamide or aromatic polyamide or polyethylene terephthalate or regenerated cellulose or metal or carbon or glass or ultra-high molecular weight polyethylene or polypropylene or polyacrylonitrile or PBO (poly(p-phenylene-2,6-benzobisoxazole)) or PBI (polybenzimidazole) or PPS (polyphenylene sulphide) or organic fibres or combinations thereof.

A twenty-second embodiment of the invention is an annular object according to the twentieth or twenty-first embodiment, characterised in that said object is a vehicle tyre, and that the annular multiaxial laid fabric (2) is integrated into the tyre casing.

### BRIEF DESCRIPTION OF THE DRAWINGS

Embodiments of the invention are explained herein by means of the drawings below. In the figures:

FIG. 1 is a side view of a multiaxial machine according to the invention

FIG. 2 is a side view, rotated through 90 degrees, of the multiaxial machine shown in FIG. 1

FIG. 3a to show a method sequence for forming an annular multiaxial laid fabric FIG. 3d

FIG. 4 is a side view of the annular multiaxial laid fabric having a spacer fabric from FIG. 3d

FIG. 5 is a spatial schematic representation of an annular multiaxial laid fabric and a related sectional detailed diagram

FIG. 6 is a spatial schematic representation of a further annular multiaxial laid fabric and a related sectional detailed diagram

### DETAILED DESCRIPTION

The object of the invention is therefore to create a method and a device for forming a multiaxial laid fabric for annular structures which has no twisting or displacement of the thread layers. Furthermore, it should no longer be necessary to close a butt join or overlap separately to form a closed ring of the multiaxial laid fabric.

According to the invention, this is achieved with a method having the features of Claim 1. Advantageous embodiments of the method can be found in Claims 2 to 9. The method comprises the following steps:
a. Laying of a lower thread layer in the form of an endless thread array or an endless single thread, or in the form of thread-array sections or single-thread sections around the entire circumference of two mutually spaced ring elements, the thread array or the single thread or the thread-array sections or the single-thread sections of the lower thread layer being held temporarily, after laying, by thread-holding elements arranged around the circumference of the ring elements, and the threads of the thread array or the thread-array sections, or the single thread or the single-thread sections of the lower thread layer forming an angle within the range greater than 0 degrees up to 90 degrees to the circumferential direction of the ring elements,
b. Laying of an upper thread layer in the form of an endless thread array or an endless single thread, or in the form of thread-array sections or single-thread sections, around the entire circumference of the two mutually spaced ring elements, the thread array or the single thread, or the thread-array sections or the single-thread sections, of the upper thread layer being held temporarily, after laying, by the thread-holding elements arranged around the ring circumference, and the threads of the thread array, or the single thread or the thread-array sections or the single-thread sections, of the upper thread layer forming an angle greater than 0 degrees to the threads of the thread array or the single thread or the thread-array sections or the single-thread sections of the lower thread layer,
c. Fixing the threads of the thread array or the single thread, or the thread-array sections or the single-thread sections, of the lower thread layer at points to the threads of the thread array or the single thread, or the thread-array sections or the single-thread sections, of the upper thread layer by means of a fixing unit around the circumference of the first and upper thread layers laid in a ring,
d. Detaching the first and upper thread layers from the thread-holding elements,
e. Removing the annular multiaxial laid fabric from the mutually spaced ring elements.

With the method, the thread layers are already brought into their shape intended for the subsequent product by laying them around the entire circumference of the ring elements before fixing the threads. Curving of thread layers already fixed to one another is no longer necessary, and therefore twisting and displacement of the thread layers by curving are avoided. Since the thread layers are laid on the ring elements in the form of an endless thread array or an endless single thread, or in the form of thread-array sections or single-thread sections, there is also no butt joint or overlap needing to be subsequently closed, in contrast to the subsequent curving of the thread layers. With the laying of the thread layers with different thread orientations, an annular multiaxial laid fabric is formed.

Between the lower thread layer and the upper thread layer, a further thread layer or further thread layers in the form of an endless thread array or an endless single thread, or in the form of thread-array sections or single-thread sections, can be laid around the entire circumference of the two mutually spaced ring elements and held with the thread-holding elements, the threads of the thread array or the single thread, or the thread-array sections or the single-thread sections, of the further thread layer forming an angle greater than 0 degrees to the threads of the thread array or the single thread, or the thread-array sections or the single-thread sections, of the respectively adjacent thread layers. The multiaxial laid fabric can be constructed according to the requirements of each case in terms of stability, tensile strength, flexibility, etc., via the number of the further thread layers and the orientation of the threads of the further thread layers.

The threads of the thread array or the single thread, or the thread-array sections or the single-thread sections, of the lower thread layer and/or the upper thread layer and/or the further thread layers can be formed from identical or differing materials. The threads inside each of the thread arrays can also be formed from identical or differing materials (hybrid fibre bundles). By suitable selection and/or combination of materials, the multiaxial laid fabric can be further adapted to the requirements of each case in terms of stability, tensile strength, flexibility, etc.

For the fixing of the thread layers at points, the threads are, for example, stitch bonded with a stitching thread, or stapled with staple elements, or thermally fixed.

When the thread layers are laid, a flat layer material or a standing-thread layer can be laid around the entire circumference between parts of the thread layers. This layer material can provide further functional properties in the multiaxial laid fabric. The flat layer material can, for example, be a separating film and/or a nonwoven fabric and/or a spacer fabric. The filler threads are laid in such a manner that they are oriented parallel to the ring circumferential direction.

In one advantageous embodiment, before the fixed thread layers are detached from the thread-holding elements of the ring elements, a polymeric matrix material is applied to an inner side of the annular multiaxial laid fabric and/or to an outer side of the annular multiaxial laid fabric. The mechanical properties can thereby be adapted further to the respective application of the annular multiaxial laid fabric.

Furthermore, a multiaxial machine having the features of Claim 10 is proposed for producing an annular multiaxial laid fabric using the method according to the invention. Advantageous embodiments are disclosed in Claims 11 to 18. The multiaxial machine has two mutually spaced ring elements, which are fixed in position relative to each other and have thread-holding elements arranged around the ring circumference; at least one first thread-laying unit, which is guided on a first feed gantry and fed by a first thread feed, for laying a thread layer in the form of an endless thread array or an endless single thread, or in the form of thread-array sections or single-thread sections on the two mutually spaced ring elements; and a fixing unit for locally fixing the threads of the thread layers laid on the ring elements. The first thread-laying unit is movable on the first feed gantry to and fro between the ring elements transverse to the circumferential direction of the ring elements. The first feed gantry and the ring elements, which are fixed in position relative to each other, can be rotated relative to each other in the circumferential direction.

In a further embodiment, the multiaxial machine has at least one second thread-laying unit, which is guided on a second feed gantry and supplied by a second thread feed, for laying a further thread layer in the form of an endless thread array or an endless single thread, or in the form of thread-array sections or single-thread sections, on the two mutually spaced ring elements. The second thread-laying unit is movable on the second feed gantry to and fro between the ring elements transverse to the circumferential direction of the ring elements. The second feed gantry and the ring elements, which are fixed in position relative to each other, can be rotated relative to each other in the circumferential direction.

It is proposed that an outer contour of the two ring elements be congruent or that an outer contour of one ring element be larger than an outer contour of the other ring element.

Furthermore, the multiaxial machine has a feed device for feeding and laying a flat layer material on the thread layer or on the further thread layer.

It is proposed that the fixing unit be a stapling unit, a stitch-bonding unit or a heating unit.

One embodiment provides for the ring elements to have a circular or oval or elliptical outer contour. In principle, it is also not excluded that one of the ring elements has, for example, a circular outer contour and the other ring element has, for example, an elliptical outer contour.

One embodiment provides for the ring elements to have an outer contour in the shape of a regular polygon.

With circular ring elements, it is preferred if the lower thread layer is laid with an angle of 90 degrees between the threads of the thread array or the thread-array sections, or the single thread or the single-thread sections, of the first layer, and the circumferential direction of the ring elements. Laying in this manner best transfers the round outer contour of the ring elements to the inner contour of the lower thread layer. With the laying of the thread layers on ring elements with identical outer contours, a multiaxial annular laid fabric in the form of a cylinder is produced. If the outer contours of the ring elements differ in extent, a multiaxial annular laid fabric in the form of a truncated cone is produced. The smaller the angle between the threads of the thread array or the thread-array sections, or the single thread or the single-thread sections, of the lower thread layer and the circumferential direction of the ring elements, the more the inner contour of the lower thread layer laid on the ring elements deviates from the outer contour of the ring elements in the region between the rings, but this is not necessarily disadvantageous, depending on the application.

In one advantageous embodiment, a supporting element for supporting the lower thread layer laid on the ring elements is provided between the two mutually spaced ring elements at least in some sections around the ring circumference. By means of said supporting element, the desired inner contour of the annular multiaxial laid fabric is maintained when the thread layers are laid, in particular if the lower thread layer is laid on circular ring elements at an angle of less than 90 degrees to the ring circumferential direction.

It is proposed that the supporting element be a strip element which runs in at least some sections around the ring circumference. This strip element is arranged on an inner side of the annular multiaxial laid fabric being formed.

In one advantageous embodiment, the thread-holding elements are needles that, together, form a crown of needles around the ring elements. During laying, the thread array or the single thread is laid around these needles, so that a fixing of the thread to the ring elements is achieved therewith. In an alternative embodiment, the thread-holding elements are clamping elements, which are arranged along the ring elements and fix the threads or the thread sections.

Also claimed is an annular object having an annular multiaxial laid fabric produced by the method according to the invention.

It is proposed that the threads of the lower thread layer and/or of the upper thread layer and/or of the further thread layer and/or of the further thread layers and/or the flat layer material be formed from polyamide or aromatic polyamide or polyethylene terephthalate or regenerated cellulose or metal or carbon or glass or ultra-high molecular weight polyethylene or polypropylene or polyacrylonitrile or PBO (poly(p-phenylene-2,6-benzobisoxazole)) or PBI (polybenzimidazole) or PPS (polyphenylene sulphide) or organic fibres or combinations thereof.

One embodiment provides for the annular object to be a vehicle tyre and for the annular multiaxial laid fabric to be integrated into the tyre casing.

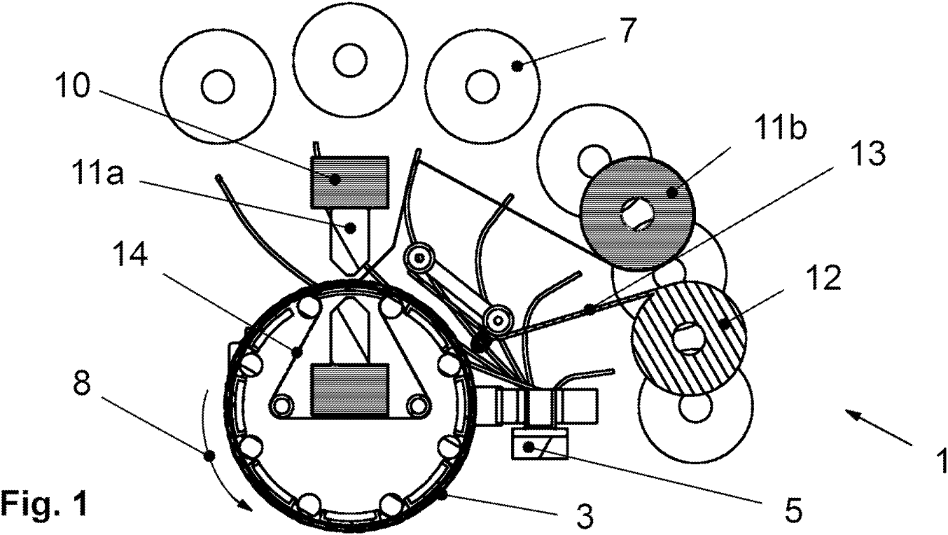

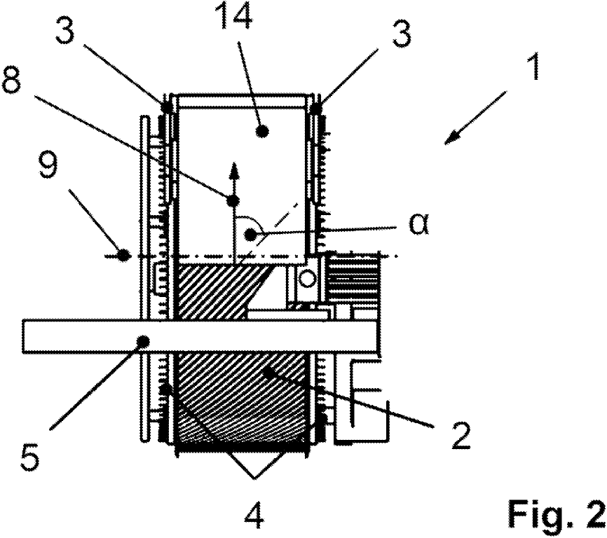

FIG. 1 is a side view of a multiaxial machine 1 according to the invention for producing an annular multiaxial laid fabric 2. FIG. 2 s a side view, rotated through 90 degrees, of the multiaxial machine 1 shown in FIG. 1. The multiaxial machine 1 has two mutually spaced ring elements 3, which are fixed in position relative to each other and have thread-holding elements 4 arranged around the ring circumference. In the embodiment shown, the thread-holding elements 4 are needles that, together, form a crown of needles around the ring elements 3. The dimensions of the ring elements 3 are matched to the dimensions of the annular multiaxial laid fabric 2. Furthermore, the multiaxial machine 1 has a thread-laying unit 6 which is guided on a feed gantry 5. In the embodiment shown, the thread-laying unit 6 is supplied by a thread feed formed from six thread bobbins 7 (the thread feed is not shown in FIG. 2). The thread-laying unit 6 is movable on the feed gantry 5 to and fro between the ring elements 3 transverse to the circumferential direction 8 of the ring elements 3. The feed gantry 5 and the ring elements 3, which are fixed in position relative to each other, can be rotated relative to each other in the circumferential direction 8. To this end, the two ring elements 3 can be rotated together clockwise or anti-clockwise about their rotational axes 9 by means of a drive device (not shown), or the feed gantry 5 can be guided clockwise or anti-clockwise in the circumferential direction 8 on the outer contour of the ring elements 3 by means of a drive device (not shown). A combination of both movements is also possible.

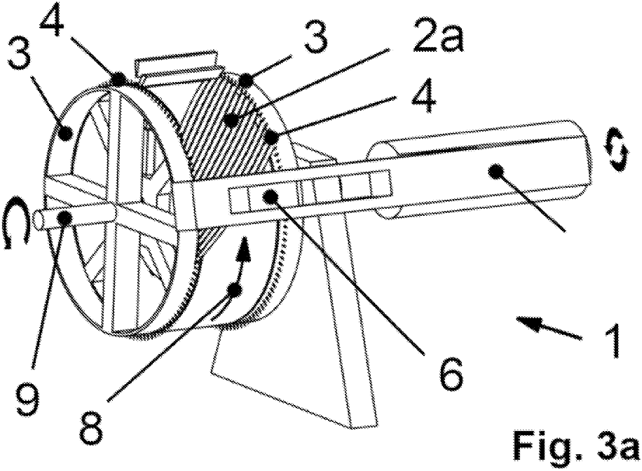

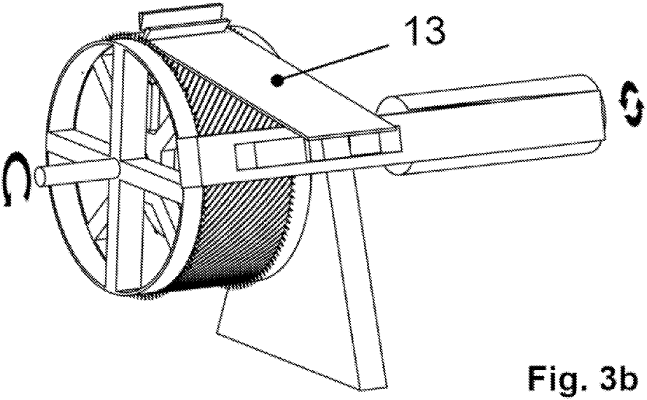

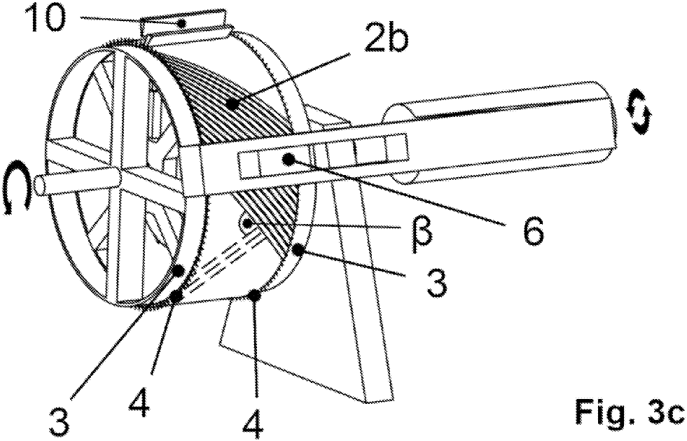

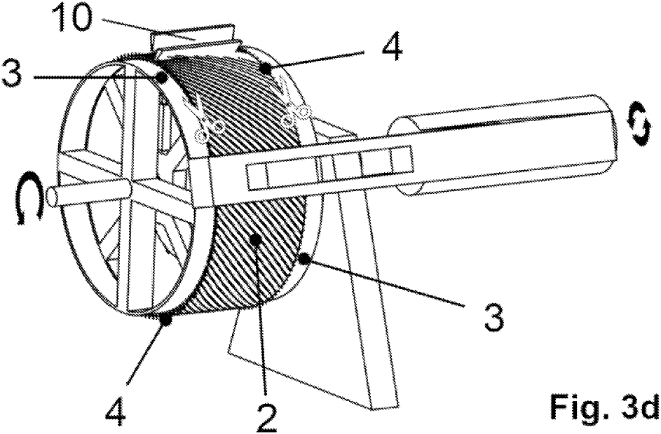

According to the invention, at least a lower thread layer 2a (FIG. 3a) and an upper thread layer 2b (FIG. 3c) are laid on the ring elements 3 to form an annular multiaxial laid fabric 2. To lay the lower thread layer 2a, the thread-laying unit 6 is used to lay an endless thread array, provided by the thread feed, on the two mutually spaced ring elements 3, the thread array being held temporarily by the thread-holding elements 4 arranged around the ring circumference. In the embodiment shown, the thread array is laid around the needles of the needle crown and thus held on the respective ring element 3 during laying. The laying of the thread array and the laying around the needles of a ring element 3 form a laying sub-step. To lay the thread array around the entire circumference, multiple laying sub-steps must be carried out, the thread array being guided alternately around some of the needles of one ring element 3 and around some of the needles of the other ring element 3 during laying. The orientation of the threads of the lower thread layer 2a relative to the circumferential direction 8 can be set via an interaction between the speed of movement of the thread-laying unit 6 along the feed gantry 5 and the mutual rotation of the feed gantry 5 and the ring elements 3 in the circumferential direction 8. The threads of the thread array of the lower thread layer 2a form an angle α within the range greater than 0 degrees up to 90 degrees to the circumferential direction 8. The faster the mutual rotation of the feed gantry 5 and the ring elements 3, or the slower the speed of movement of the thread-laying unit 6 along the feed gantry 5, the smaller the angle α between the threads and the circumferential direction 8. If there is no mutual rotation of the feed gantry 6 and the ring elements 3 when the thread-laying unit 6 moves along the feed gantry 5 in a laying sub-step during laying of the threads, an angle α of 90 degrees is produced between the threads and the circumferential direction. Depending on the width of the thread array, multiple laying sub-steps are needed to achieve coverage over the entire circumference of the ring elements 3. The width of the thread array is determined by the number of the mutually adjacent threads of a thread bundle. The dimensions of the thread array can be adapted such that the circumferential length of the ring elements 3 is an integer multiple of the width of the thread array. However, this is not necessary, and therefore, when the thread array is laid around the entire circumference, some of the threads of the last laying sub-step of the thread array may overlap with some of the first laying of the thread array.

By means of a further revolution, an upper thread layer 2b is analogously laid around the entire circumference of the two mutually spaced ring elements 3. By changing the speed of movement of the thread-laying unit 6 along the feed gantry 5 and/or the mutual rotation of the feed gantry 5 and the ring elements 3, the orientation of the threads of the upper thread layer 2b is changed relative to the threads of the lower thread layer 2a, and therefore the laying of the lower thread layer 2a and the upper thread layer 2b is multiaxial. The threads of the thread array of the upper thread layer 2b form an angle β (FIG. 3c) greater than 0 degrees with the threads of the thread array of the lower thread layer 2a. In the upper thread layer 2b, as is likewise the case in the lower thread layer 2a, it is also possible to lay a single thread instead of laying a thread array around the entire circumference.

After the lower thread layer 2a and the upper thread layer 2b have been laid, the threads of the lower thread layer 2a are fixed at points to the threads of the upper thread layer 2b around the entire circumference. To this end, the multiaxial machine 1 has a fixing unit 10. The fixing unit 10 can be, for example, a stapling unit or a stitch-bonding unit or a heating unit, without the invention being limited thereto. With a stapling unit, the threads of the thread layers are attached at points with staple elements. If the fixing unit is in the form of a heating unit, heat is input at points into the thread layers 2a, 2b and causes (with suitable selection of the thread materials) melting of the threads at points. On cooling, there are then integral bonds at points between the threads of the thread layers 2a, 2b. If the fixing unit 10 is in the form of a stitch-bonding unit, the threads of the thread layers 2a, 2b are connected to one another at points by means of a stitch-bonding thread. FIG. 1 shows the multiaxial machine with a fixing unit in the form of a stitch-bonding unit. The stitch-bonding unit has a stitch-bonding needle unit 11a and a stitch-bonding thread-feeding unit 11b.

In an embodiment which is not shown, the multiaxial machine 1 has at least one further thread-laying unit (analogous to the first thread-laying unit 6), which is guided on a further feed gantry and is supplied by a further thread feed. Here too, the further thread-laying unit is movable to and fro between the ring elements 3 on the further feed gantry transverse to the circumferential direction 8 of the ring elements 3, and the further feed gantry and the ring elements 3 are rotatable relative to each other in the circumferential direction. For example, the lower thread layer 2a is laid with the first thread-laying unit 6, and the upper thread layer 2b or a further thread layer is laid with the further thread-laying unit. The advantage in this case is that both thread-laying units can be arranged at an offset around the circumference of the ring elements 3, and both thread layers can be laid virtually simultaneously, with fewer than two complete mutual rotations of the feed gantry 5 and the ring elements 3 being sufficient to lay both thread layers 2a, 2b, which ultimately increases the speed for laying the thread layers 2a, 2b.

To form the multiaxial laid fabric 2, the lower thread layer 2a and the upper thread layer 2b are laid and fixed to each other. Furthermore, one or more further thread layers can also be laid between the lower thread layer 2a and the upper thread layer 2b.

After the threads have been connected at points, the thread layers 2a, 2b (and any further thread layers) are detached from the thread-holding elements 4 (for example, the thread-holding elements in the form of needles are retracted, or the threads are cut off the needles). The annular multiaxial laid fabric 2 so formed is then removed from the mutually spaced ring elements 3 (for example, pushed down from the ring elements 3 in an axial direction).

The multiaxial machine 1 in FIG. 1 has an optional feed apparatus 12 for feeding and laying a flat layer material 13 around the entire circumference of a laid thread layer. The flat layer material 13 can be laid on the lower thread layer 2a or on a further thread layer arranged between the first and upper thread layers 2a, 2b, or else on the upper thread layer 2a. Multiple flat layer materials 13 can likewise be inlaid during the formation of the annular multiaxial laid fabric 2; for example, a flat layer material 13 can be laid in each case around the entire circumferential of the respective thread layer between the lower thread layer 2a and a further thread layer and between the further thread layer and the upper thread layer 2b. When the thread layers 2a, 2b are fixed at points, the flat layer materials 13 are likewise fixed between the thread layers 2a, 2b. If, for example, stapling or stitch-bonding is used for fixing, the flat layer materials 13 are pierced by the stapling elements or the stitch-bonding needles, and the staples or the stitch-bonding thread are/is guided through the flat layer materials 13, as a result of which the latter are fixed to the thread layers 2a, 2b. The flat layer materials 13 can be, for example, a separating film and/or a nonwoven fabric and/or a spacer fabric, without the invention being limited thereto.

Furthermore, the multiaxial machine 1 shown in FIG. 1 and FIG. 2 has an optional supporting element 14. In the embodiment shown, this supporting element 14 is a strip element which runs at least in some sections around the ring circumference and is arranged between the two mutually spaced ring elements 3. This strip element reproduces at least in some sections the inner contour provided for the annular multiaxial laid fabric 2. The supporting element 14 is provided to support the lower thread layer 2a laid on the ring elements 3. This is advantageous in particular if the threads of the lower thread layer 2a and the ring circumferential direction 8 form an angle α less than 90 degrees. The smaller the angle α between the threads of the lower thread layer 2a and the ring circumferential direction 8, the more the inner contour of the lower thread layer 2a can differ from the outer contour of the ring elements 3, since the thread sections between the thread-holding elements 4 of the mutually spaced ring elements 2 always take the shortest route. The supporting element 14 is arranged such that the threads of the lower thread layer 2a, when laid on the ring elements 3, likewise lie on the supporting element 14, and thus the lower thread layer 2a is held with the inner contour provided for the annular multiaxial laid fabric 2. The strip element is either carried synchronously with a rotation of the ring elements 3 or the strip element remains stationary relative to the ring elements 3, and the threads of the lower thread layer 2a lying on the strip element slide along the strip element when the ring elements 3 rotate. If the threads of the lower thread layer 2a are laid at right angles to the ring circumferential direction 8 of the ring elements 3, the supporting element 14 can also be omitted.

In the embodiment shown, the outer contours of the ring elements 3 are circular. The multiaxial machine 1 according to the invention is not limited to this embodiment, however. For example, the ring elements 3 can also have an oval or elliptical contour or an outer contour in the shape of a regular polygon. Furthermore, the rotational axes 9 of the two ring elements 3 in the embodiment shown in FIG. 1 are oriented axially to each other. This is also not mandatory. The rotational axes 9 of the two ring elements 3 can also be shifted parallel to each other.

The invention is not limited to thread-holding elements 4 in the form of needles. For example, the thread-holding elements 4 can also be in the form of clamping elements.

As an alternative to a thread array, it is also possible to lay an endless single thread around the entire circumference, in which case, however, more laying sub-steps are necessary for laying around the entire circumference when compared with laying a thread array. Likewise, single-thread sections or thread-array sections can also be laid on the two ring elements 3 instead of laying an endless thread array or an endless single thread. The single-thread sections or the thread-array sections can be cut from an endless thread or an endless thread array during laying. The single-thread sections or the thread-array sections can also be supplied pre-cut to the length matching the ring spacing and laid on the ring elements 3.

The threads of the thread array or the single thread of the lower thread layer 2a and/or the upper thread layer 2b and/or the further thread layer and/or the further thread layers can be formed from identical or differing materials. Furthermore, the threads within the thread arrays can also be formed from identical or differing materials (hybrid fibre bundle).

FIG. 3a to FIG. 3d show a method sequence for forming an annular multiaxial laid fabric 2 having the lower thread layer 2a, the upper thread layer 2b and a flat layer material 13 inlaid between the first and upper thread layers 2a, 2b. In a first step, the lower thread layer 2a is laid using the thread-laying unit 6 and held using the thread-holding elements 4 (in this case likewise in the form of a needle rim). The threads of the lower thread layer 2a are oriented such that an angle α of 45 degrees is formed between these threads and the ring circumferential direction 8. In the diagram of FIG. 3a, the lower thread layer 2a has not yet been laid around the entire circumference of the ring elements 3. In the second step (FIG. 3b), the lower thread layer 2a has now been laid around the entire circumference, and the flat layer material 13 is fed and laid thereon around the entire circumference. The flat layer material 13 can be fed in an arc shape already cut to the appropriate length. The flat layer material 13 can also be fed in the form of rolls and cut to the appropriate length after being laid around the entire circumference. In the diagram of FIG. 3b, the flat layer material 13 has not yet been laid around the entire circumference on the lower thread layer 2a. In the third step (FIG. 3c), the upper thread layer 2b is laid using the thread-laying unit 6 and held using the thread-holding elements 4 (needle rims). The threads of the upper thread layer 2b are oriented such that an angle β of 90 degrees is formed between these threads and the threads of the lower thread layer 2a. In the diagram of FIG. 3c, the upper thread layer 2b has not yet been laid around the entire circumference of the ring elements 3. The dashed lines in FIG. 3c symbolise three threads of the lower thread layer, which is covered by the flat layer material 13. After the upper thread layer 2b has been laid around the entire circumference, the threads of the thread layers 2a, 2b are stitch-bonded to the flat layer material 13 lying there between by means of the fixing unit 10 in the form of a stitch-bonding unit. In the fourth step (FIG. 3d), the threads of the first and upper thread layers 2a, 2b are detached from the thread-holding elements 4 in the form of needle crowns by cutting, so that the annular multiaxial laid fabric 2 can then be removed from the ring elements 3.

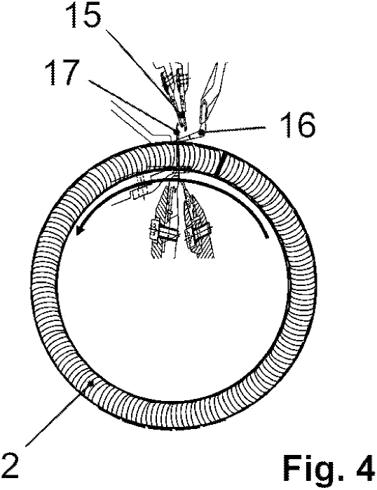

FIG. 4 is a side view of the annular multiaxial laid fabric 2 having a spacer fabric from FIG. 3d. Also shown are the piercing needles 15 of the laying bars, the knockover plate 16 and the stitch-bonding needle 17 and slide of the stitch-bonding unit. In the diagram, the piercing needles 15 of the laying bars and the knockover plate 16 are arranged on the outside of the annular multiaxial laid fabric 2, and the stitch-bonding needle 17 and slide with the stitch-bonding needle guide are arranged on the inside of the annular multiaxial laid fabric 2. In principle, however, a reversed arrangement of the stitch-bonding unit is also possible. To allow the finished annular multiaxial laid fabric 2 to be removed, a carrier structure of the stitch-bonding unit should be C-shaped so that the annular multiaxial laid fabric 2 can be guided out of the stitch-bonding unit via the open side of the C-shaped carrier structure. To guide the annular multiaxial laid fabric 2 out, either the stitch-bonding unit can be moved axially to the ring elements 3 or the ring elements 3 are moved axially to the stitch-bonding unit. If a supporting element 14 in the form of a strip element is used, the strip element is guided in the region of the stitch-bonding unit past the elements of the stitch-bonding unit in some sections, so that the inside of the annular multiaxial laid fabric 2 is exposed in the region of the stitch-bonding unit and can be pierced by the stitch-bonding needle 17 with the slide (cf. FIG. 1). Optionally, the inside of the annular multiaxial laid fabric 2, which is exposed in some sections, can be closed during the laying process by means of pivoting flaps or slide elements (not shown). For passing into and out of the stitch-bonding point, the size of the gap must be selected accordingly, or else spread open, in order to allow the closed needle rims through without colliding with the stitch-bonding elements.

The method described can be used to produce multiaxial laid fabric 2 with a closed ring shape. Preferably, the method is used to produce multi-layered multiaxial laid structures having additional flat layers, preferably spacer textiles and preferably spacer fabrics. All organic or inorganic endless fibres, such as polyester, polyethylene, polyamide, carbon, glass, basalt, aramid, cellulose, are used as thread materials for the weft and filler threads; polyester, polypropylene and polyamide are preferably used for the stitch-bonding thread. Metallic threads or strands consisting of steel or aluminium are also used as filler-thread materials.

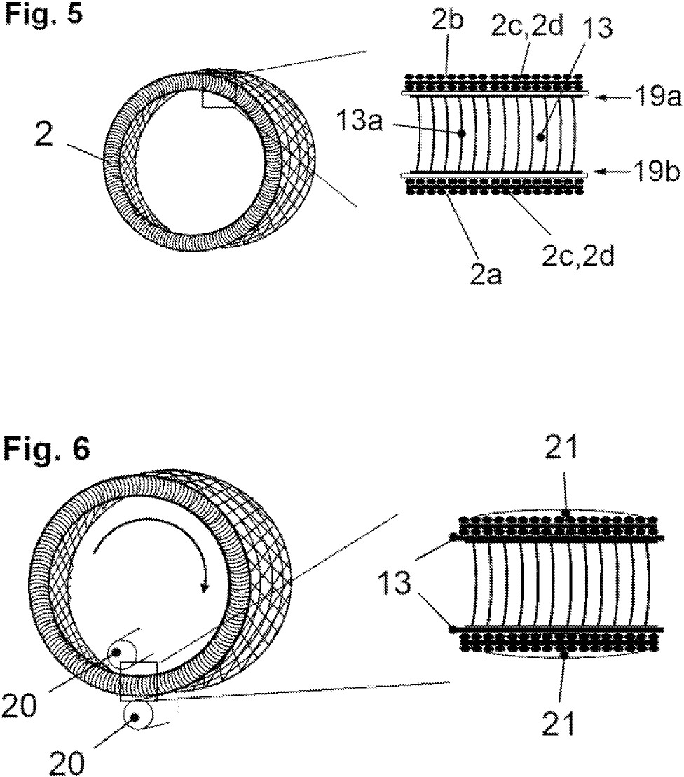

A typical variant is the laying of multiaxial thread layers of glass fibres in a first step, laying a spacer fabric consisting of polyester in a thickness of 2-20 mm, preferably 5-12 mm, in particular 8 mm, in a second step, and again laying multiaxial thread layers of glass fibres in a third step. Preferably, the upper and lower thread layers are identical in terms of the number of layers, weight per unit area and fibre type and are mirror-symmetrical to the spacer fabric layer in terms of their fibre orientation. FIG. 5 shows a three-dimensional schematic diagram of an annular multiaxial laid fabric 2 with a flat layer material 13 in the form of a spacer fabric. The layer structure of this laid fabric 2 is shown in more detail in a detailed diagram. The spacer fabric is covered on the outside 19a by the upper thread layer 2b and two further thread layers 2c lying thereunder. Two further thread layers 2d and the lower thread layer 2a lie on the inside 19b of the spacer fabric. The threads of mutually adjacent thread layers form an angle β greater than 0 degrees.

An advantage of this structure is that the butt joint of the spacer fabric, at which the two end faces of the spacer fabric meet in the ring shape and which actually forms a weak point in the overall textile structure on mechanical loading, no longer has any negative effects thanks to the subsequent stitch-bonding of the entire layer structure. Further advantageous properties of the annular structure produced in this manner result when the multiaxial thread layers on the inside and outside of the annular structure and the outsides of the spacer fabric, with the exception of the loop piles 13a of the spacer fabric, are then embedded in a polymeric matrix material and thus form a material bond. In one extension of the method according to the invention, after the threads of the thread layers have been fixed at points, a polymeric matrix material 21 is applied to an inner side of the annular multiaxial laid fabric and/or an outer side of the annular multiaxial laid fabric using an application device 20 (see FIG. 6). The polymeric matrix material 21 is preferably a reactive resin, preferably a polyurethane. Preferably, the viscosity of the reactive resin is set such that the fibres of the multiaxial thread layers and outer sides of the spacer fabric are completely impregnated, but the loop piles 13a of the spacer fabric are not embedded in the reactive resin mixture during the embedding process. To prevent the polymeric matrix material 21 from penetrating further into the spacer fabric, the spacer fabric can be covered on one or both sides with a separating film. The spacer fabric can be inlaid already prefabricated together with the separating film as a flat layer material 13 between the thread layers 2a, 2b during the laying process. However, the spacer fabric and the separating film can likewise be fed successively as separate flat layer materials 13 during the laying process.

With the method according to the invention, multi-layered multiaxial ring structures are produced, which can be used to produce various annular objects. One possible annular object can be a motor-vehicle tyre (an airless, lightweight tyre, for example), in which the annular multiaxial laid fabric 2 is integrated into the tyre casing. Particularly in this intended use, the embedding of the upper or lower thread layers of the annular multiaxial laid fabric in a polymeric matrix material is advantageous. On one hand, the necessary fibre-reinforcement effect is produced. On the other, good material bonding is achieved to the tyre casing formed from synthetic rubber or natural rubber using a vulcanisation process. A low-viscosity reactive mixture or molten thermoplastic, for example, can be used for the embedding of the thread layers. However, it must be ensured, depending on the structure of the textile layer structure, that only a defined number of layers is impregnated by the plastic in the thickness direction. Particular in the preferred textile layer structure with a spacer fabric as the middle layer and outer layers of multiaxial laid fabrics, in order to maintain its textile deformation properties under compressive stress, the spacer fabric should not be impregnated. To this end, the loop piles of the spacer fabric must not be embedded, which can be ensured by inlaying separating films during the laying process. Preferably, thin polymer films are used, which can be pierced during stitch-bonding or stapling of the thread layers. Depending on the matrix material used, different thermoplastic films can be used, which enter into a good integral bond with the matrix. These can be films based for example on PP, PE, nylon 6, nylon 6,6, TPU [thermoplastic polyurethane], PLA [polylactic acid]. The stitch-bonding of the film to the textile layers also proves advantageous in this case, since the stitch-bonding thread has flow channels through the film in the thickness direction which fill easily with the matrix owing to the capillary forces and thus locally fixes the film well to the surrounding textile layers.

The threads of the lower thread layer 2a and/or of the upper thread layer 2b and/or of the further thread layer and/or of the further thread layers and/or the flat layer material 13 are preferably formed from polyamide or aromatic polyamide or polyethylene terephthalate or regenerated cellulose or metal or carbon or glass or ultra-high molecular weight polyethylene or polypropylene or polyacrylonitrile or PBO (poly(p-phenylene-2,6-benzobisoxazole)) or PBI (polybenzimidazole) or PPS (polyphenylene sulphide) or organic fibres or combinations thereof.

List of reference numbers

| | |
|---|---|
| 1 | Multiaxial machine |
| 2 | Annular multiaxial laid fabric |
| 2 a | Lower thread layer |
| 2 b | Upper thread layer |
| 2 c | Further thread layer |
| 2 d | Further thread layer |
| 3 | Ring element |
| 4 | Thread-holding element |
| 5 | Feed gantry |
| 6 | Thread-laying unit |
| 7 | Thread bobbin |
| 8 | Circumferential direction of ring elements 3 |
| 9 | Rotational axes of ring elements 3 |
| 10 | Fixing unit |
| 11 a | Stitch-bonding needle unit |
| 11 b | Stitch-bonding thread-feeding unit |
| 12 | Feed device |
| 13 | Flat layer material |
| 13 a | loop piles |
| 14 | Supporting element |
| 15 | Piercing needles |
| 16 | Knockover plate |
| 17 | Stitch-bonding needle with slide |
| 18 | Inside of annular multiaxial laid fabric 2 |
| 19 a | Outside of flat layer material 13 |
| 19 b | Inside of flat layer material 13 |
| 20 | Application device |
| 21 | Polymeric matrix material |
| α | Angle between threads of a thread layer and circumferential direction 8 |
| β | Angle between threads of adjacent thread layers |

1. A method for producing an annular multiaxial laid fabric, which is constructed from at least two thread layers laid one on top of the other, the method comprising the following steps:
a. Laying of a lower thread layer in the form of an endless thread array or an endless single thread, or in the form of thread-array sections or single-thread sections, around the entire circumference of two mutually spaced ring elements, the thread array or the single thread, or the thread-array sections or the single-thread sections, of the lower thread layer being held temporarily, after laying, by thread-holding elements arranged around the ring circumference, and the threads of the thread array or the thread-array sections or the single thread or the single-thread sections of the lower thread layer forming an angle (α) within the range greater than 0 degrees up to 90 degrees to the circumferential direction of the ring elements,
b. Laying of a upper thread layer in the form of an endless thread array or an endless single thread, or in the form of thread-array sections or single-thread sections, around the entire circumference of the two mutually spaced ring elements, the thread array or the single thread, or the thread-array sections or the single-thread sections, of the upper thread layer being held temporarily, after laying, by the thread-holding elements arranged around the ring circumference, and the threads of the thread array or the single thread, or the thread-array sections or the single-thread sections, of the upper thread layer forming an angle (β) greater than 0 degrees to the threads of the thread array or the single thread, or the thread-array sections or the single-thread sections, of the lower thread layer,
c. Fixing the threads of the thread array or the single thread, or the thread-array sections or the single-thread sections, of the lower thread layer at points to the threads of the thread array or the single thread, or the thread-array sections or the single-thread sections, of the upper thread layer by means of a fixing unit around the circumference of the first and upper thread layers laid in a ring,
d. Detaching the first and upper thread layers from the thread-holding elements, and
e. Removing the annular multiaxial laid fabric from the mutually spaced ring elements.

2. The method of claim 1, wherein at least one further thread layer in the form of an endless thread array or an endless single thread, or in the form of thread-array sections or single-thread sections, is laid around the entire circumference of the two mutually spaced ring elements between the first and upper thread layers, the thread array or the single thread, or the thread-array sections or the single-thread sections, of the further thread layer being held temporarily, after laying, by the thread-holding elements arranged around the ring circumference, and the threads of the thread array or the single thread, or the thread-array sections or the single-thread sections, of the further thread layer forming an angle greater than 0 degrees to the threads of the thread array or the single thread, or the thread-array sections or the single-thread sections, of the first and upper thread layers.

3. The method of claim 2, wherein two or more further thread layers are laid between the first and upper thread layers, the threads of the thread array or the single thread, or the thread-array sections or the single-thread sections, of the further thread layer forming an angle greater than 0 degrees to the threads of the thread array or the single thread, or the thread-array sections or the single-thread sections, of the respectively adjacent thread layers.

4. The method of claim 1, wherein the threads of the thread array or the single thread, or the thread-array sections or the single-thread sections, of the lower thread layer and/or the upper thread layer and/or the further thread layer and/or the further thread layers are formed from identical or differing materials.

5. The method of claim 1, wherein threads within one of the thread arrays or thread array sections are formed from identical or differing materials.

6. The method of claim 1, wherein, for the fixing of the thread layers at points, the threads are stitch-bonded with a stitch-bonding thread or stapled with staple elements or thermally fixed.

7. The method of claim 1, wherein, after the lower thread layer has been laid, or after the further thread layer has been laid, or after the upper thread layer has been laid, a flat layer material or a filler-thread layer is laid around the entire circumference.

8. The method, of claim 8, wherein the flat layer material is a separating film and/or a nonwoven fabric and/or a spacer fabric.

9. The method, of claim 1, wherein, after the threads of the thread layers have been fixed at points, a polymeric matrix material is applied to an inner side of the annular multiaxial laid fabric (2) and/or an outer side of the annular multiaxial laid fabric.

10. A multiaxial machine for producing an annular multiaxial laid fabric, wherein, the multiaxial machine has two mutually spaced ring elements, which are fixed in position relative to each other and have thread-holding elements, arranged around the ring circumference; at least one first thread-laying unit, which is guided on a first feed gantryand is supplied by a first thread feed, for laying at least a lower thread layer and a upper thread layerin the form of an endless thread array or an endless single thread, or in the form of thread-array sections or single-thread sections, on the two mutually spaced ring elements; and a fixing unit for locally fixing the threads of the first and upper thread layers laid on the ring elements; and that the first thread-laying unit is movable on the first feed gantryto and fro between the ring elements transverse to the circumferential directionof the ring elements; and that the first feed gantryand the ring elementswhich are fixed in position relative to each other can be rotated relative to each other in the circumferential direction .

11. The multiaxial machine in of claim 10, wherein the multiaxial machine has at least one second thread-laying unit, which is guided on a second feed gantry and is supplied by a second thread feed, for laying a further thread layerin the form of an endless thread array or an endless single thread, or in the form of thread-array sections or single-thread sections, on the two mutually spaced ring elements, and that the second thread-laying unit is movable on the second feed gantry to and fro between the ring elements transverse to the circumferential directionof the ring elements, and that the second feed gantry and the ring elements which are fixed in position relative to each other can be rotated relative to each other in the circumferential direction.

12. The multiaxial machine, of claim 10, wherein an outer contour of the two ring elements is congruent or that an outer contour of one ring element is larger than an outer contour of the other ring element.

13. The multiaxial machine of claim 10, wherein the multiaxial machine has a feed device for feeding and laying a flat layer material on the thread layer and/or the further thread layer.

14. The multiaxial machine of claim 10, wherein the fixing unit is a stapling unit, a stitch-bonding unit or a heating unit.

15. The multiaxial machine of claim 10, a supporting element for supporting the lower thread layerlaid on the ring elements is provided between the two mutually spaced ring elements at least in some sections around the ring circumference.

16. The multiaxial machine the supporting element is a strip element which runs in at least some sections around the ring circumference.

17. The multiaxial machine of claim 10, wherein the ring elements have a circular or oval or elliptical outer contour.

18. The multiaxial machine of claim 10, wherein the ring elements have an outer contour in the shape of a regular polygon.

19. The multiaxial machine of claim 10, wherein the thread-holding elements are needles which in each case of each of the ring elements form a crown of needles along the ring elements, or that the thread-holding elements are clamping elements arranged along the ring elements.

20. An annular object, comprising an annular multiaxial laid fabric produced by a method according to claim 1.

21. The annular object of claim 20, wherein the threads of the lower thread layer and/or of the upper thread layer and/or of the further thread layer and/or of the further thread layers, and/or the flat layer material are formed from polyamide or aromatic polyamide or polyethylene terephthalate or regenerated cellulose or metal or carbon or glass or ultra-high molecular weight polyethylene or polypropylene or polyacrylonitrile or PBO (poly(p-phenylene-2,6-benzobisoxazole)) or PBI (polybenzimidazole) or PPS (polyphenylene sulphide) or organic fibres or combinations thereof.

22. The annular object of claim 21, wherein the annular object is a vehicle tyre, and that the annular multiaxial laid fabric is integrated into the tyre casing.
